(19) United States
(12) Patent Application Publication
(10) Pub. No.: US 2025/0149863 A1
(43) Pub. Date: May 8, 2025

(54) NOBLE METAL PIN FOR SPARK PLUG ELECTRODE, SPARK PLUG ELECTRODES, SPARK PLUG AND METHOD OF PRODUCING THE SPARK PLUG ELECTRODES

(71) Applicant: Robert Bosch GmbH, Stuttgart (DE)

(72) Inventors: Moritz Wenk, Stuttgart (DE); Paul Justus Sieffert, Stuttgart (DE)

(21) Appl. No.: 18/838,339

(22) PCT Filed: Mar. 15, 2023
(86) PCT No.: PCT/EP2023/056539

§ 371 Date: Aug. 14, 2024

(30) Foreign Application Priority Data
Mar. 23, 2022 (DE) 10 2022 202 816.3

(51) Int. Cl. H01T 13/39; C22C 5/04; H01T 21/02

(52) U.S. Cl. CPC H01T 13/39; C22C 5/04; H01T 21/02

(57) ABSTRACT

A noble metal pin for a spark plug electrode. The pin includes an alloy containing more than 80 mass platinum, 1 to 10 mass nickel and 1 to less than 10 mass iridium.

### FIELD

The present invention relates to a noble metal pin for a spark plug electrode for use in spark formation on a spark plug electrode for internal combustion engines and to spark plug electrodes formed with the noble metal pin for a spark plug electrode. Furthermore, the present invention also relates to a spark plug and to methods for producing the spark plug electrodes.

### BACKGROUND INFORMATION

Spark plug electrodes with noble metal pins or spark plug electrodes made of noble metals are described in the related art. For example, German Patent Application No. DE 10 2013 210 453 A1 describes a spark plug electrode material that is characterized by good corrosion resistance and low spark erosion wear. The spark plug electrode material contains a first noble metal selected from Pd, Au, Ag, Re, Os and Ru, Ni in a proportion of 0.5 to 5 wt. %, based on the total weight of the spark plug electrode material, and Rh in a proportion of 0.5 to 50 wt. %, based on the total weight of the spark plug electrode material. A disadvantage of these spark plug electrodes is that they are subject to excessive wear and associated high costs.

### SUMMARY

According to the present invention, a noble metal pin for a spark plug electrode is provided, which is characterized by very good processability with very high wear resistance and can be easily attached to a spark plug electrode main body by, for example, a welding method, without losing its advantageous properties.

According to an example embodiment of the present invention, the noble metal pin for a spark plug electrode according to the present invention consists of an alloy containing more than 80 mass % platinum, 1 to 10 mass % nickel and 1 to less than 10 mass % iridium, in each case based on the total mass of the noble metal pin for a spark plug electrode. While platinum and platinum alloys containing iridium are characterized by a low wear rate due to spark erosion, platinum and platinum-iridium alloys are also characterized by high melting points. A disadvantage of these alloys with high melting points is that they are difficult to process. The above indications of the quantities of the elements of the noble metal pin for a spark plug electrode according to the present invention relate to the noble metal pin for a spark plug electrode in the uninstalled state, i.e., before the connection is formed with a spark plug electrode main body.

According to the present invention, when the noble metal pin for a spark plug electrode is used as intended, it is connected to a spark plug electrode main body. A permanently stable connection between the noble metal pin for a spark plug electrode and the spark plug electrode main body ensures a high mileage without the formation of false sparks. For this purpose, it is necessary to connect the noble metal pin for a spark plug electrode to the spark plug electrode main body by a welding method. This shows a further advantage of the composition of the noble metal pin for a spark plug electrode according to the present invention: by a proportion of 1 to 10 mass % nickel, based on the total mass of the noble metal pin for a spark plug electrode, the melting range of the alloy is lowered and thus the weldability is improved. This applies to all welding methods, but especially to back-side welding and complete alloying of the noble metal pin for a spark plug electrode into a spark plug electrode main body. Due to the welding method used, the composition of the noble metal pin for a spark plug electrode can change in the region of the connection between the spark plug electrode main body and the noble metal pin for a spark plug electrode. For example, a weld seam may be formed having a mixed composition of the composition of the noble metal pin for a spark plug electrode and the spark plug electrode main body. In the case of “simple” welding and back-side welding to form a weld seam, however, the region used for spark formation during use as intended of the noble metal pin for a spark plug electrode (hereinafter referred to as ignition spark surface) still has the following composition as disclosed above: more than 80 mass % platinum, 1 to 10 mass % nickel, and 1 to less than 10 mass % iridium, in each case based on the total mass of the noble metal pin for a spark plug electrode.

Nickel is characterized by a lower melting point than platinum and in particular iridium, while also being highly erosion-resistant, so that adding it can lower the melting range of the alloy while maintaining its excellent mechanical properties, which has a positive effect on its capability to be processed by welding.

Preferred developments and example embodiments of the present invention are disclosed herein.

According to an advantageous development of the present invention, the alloy of the noble metal pin for a spark plug electrode consists substantially of more than 80 mass % platinum, in particular more than 90 mass % platinum, 1 to 10 mass % nickel, in particular 3 to 7 mass % nickel, and 1 to less than 10 mass % iridium, and among these in particular 1 to 3 mass % iridium. Further additions of metals are not required, which facilitates the production of the noble metal pin for a spark plug electrode, saves costs, and enables a very good balance between the spark erosion properties on the one hand and the processability by welding on the other hand.

Also provided according to an example embodiment of the present invention is a first spark plug electrode comprising a noble metal pin for a spark plug electrode, which pin consists of an alloy containing more than 80 mass % platinum, 1 to 10 mass % nickel, and 1 to less than 10 mass % iridium. As explained above, the quantities in each case relate to the total mass of the noble metal pin for a spark plug electrode. In addition, it is stated that, as explained, the use of a welding method to form a connection between the noble metal pin for a spark plug electrode and the spark plug electrode main body can result in a different (mixed) composition in the connection region. However, the composition of the noble metal pin for a spark plug electrode in the region which serves to form the ignition spark when the first spark plug electrode is used as intended (ignition spark surface) always contains an alloy containing more than 80 mass % platinum, 1 to 10 mass % nickel, and 1 to less than 10 mass % iridium. The noble metal pin for a spark plug electrode can therefore be designed as disclosed above according to the present invention. Due to the use of the specifically composed noble metal pin for a spark plug electrode, the first spark plug electrode according to the present invention is also characterized by low spark erosion wear and thus by a permanently high mileage, in particular in modern engines with high power density. In addition, the spark plug electrode, or more precisely a spark plug electrode main body of the spark plug electrode, can be very easily and permanently connected to the noble metal pin for a spark plug electrode by welding, which prevents misfires and even a complete failure of the spark plug electrode when used as intended.

In an advantageous example embodiment of the first spark plug electrode of the present invention, the noble metal pin for a spark plug electrode is connected to a nickel-based electrode main body by a weld seam, and in particular by a weld seam formed by back-side welding. The noble metal pin for a spark plug electrode thus forms, together with the nickel-based electrode main body to which it is connected by welding and in particular by back-side welding, the first spark plug electrode. Welding creates only a small weld seam between the noble metal pin for a spark plug electrode and the spark plug electrode main body, so that the noble metal pin for a spark plug electrode substantially retains its composition, and in particular in the region that serves to generate the ignition spark (ignition spark surface) when the spark plug electrode is used as intended. This means that the advantageous effects contributed to the first spark plug electrode by the noble metal pin for a spark plug electrode are permanently retained.

According to the present invention, a nickel-based electrode main body is understood to mean a spark plug electrode main body which consists of nickel or of a nickel alloy, wherein in the case of a nickel alloy, the proportion of nickel is more than 50 mass % and in particular more than 80 mass %, based on the total mass of the nickel alloy. Suitable alloying metals include aluminum, silicon, yttrium, copper, iron, magnesium, manganese, titanium, zirconium, and chromium. A particularly suitable nickel alloy for use as a nickel-based electrode main body comprises the following elements: aluminum, silicon, copper, and yttrium, each with less than 5 mass %, and iron and chromium, each with up to 25 mass %, with the remainder being nickel.

According to a further preferred development of the present invention, the alloy of the noble metal pin for a spark plug electrode consists, at least in the region of the noble metal pin for a spark plug electrode which serves to form the ignition spark when the first spark plug electrode is used as intended (ignition spark surface), substantially of more than 80 mass % of platinum, in particular more than 90 mass % of platinum, 1 to 10 mass % of nickel, in particular 3 to 7 mass % of nickel, and 1 to less than 10 mass % of iridium, and in particular 1 to 3 mass % of iridium. This makes it easier to form the weld seam between the noble metal pin for a spark plug electrode and the nickel-based electrode main body and makes it permanently stable. A very low spark erosion wear rate and thus a high mileage of the spark plug are also achieved.

Furthermore, according to an example embodiment of the present invention, a second spark plug electrode is also disclosed, which comprises a noble metal pin for a spark plug electrode, wherein the noble metal pin for a spark plug electrode is completely alloyed into a nickel-based electrode main body, and wherein the noble metal pin for a spark plug electrode consists of an alloy containing 30 to 60 mass % platinum, 40 to 65 mass % nickel, and 0.5 to 5 mass % iridium.

The above-disclosed noble metal pin for a spark plug electrode according to the present invention can also be used for the second spark plug electrode. However, due to the complete alloying of the noble metal pin for a spark plug electrode into the nickel-based electrode main body, the composition of the noble metal pin for a spark plug electrode changes in all regions of the previously arranged noble metal pin for a spark plug electrode. This is due to the composition of the nickel-based electrode main body, which comprises more than 50 mass %, and in particular more than 80 mass %, nickel (based on the total mass of the nickel-based electrode main body).

In other words, the second spark plug electrode can be obtained by using a noble metal pin for a spark plug electrode, which pin consists of an alloy containing more than 80 mass % platinum, 1 to 10 mass % nickel, and 1 to less than 10 mass % iridium and completely alloying the noble metal pin for a spark plug electrode into a nickel-based electrode main body. Due to the use of the noble metal pin for a spark plug electrode, the alloying into the nickel-based electrode main body is also facilitated and the resulting connection between the noble metal pin for a spark plug electrode and the nickel-based electrode main body is permanently stable and ensures a permanently high mileage of the second spark plug electrode without the formation of false sparks. This also means that the second spark plug electrode is very well protected against spark erosion wear.

A particularly good connection formation between the noble metal pin for a spark plug electrode and the nickel-based electrode main body in the second spark plug electrode is obtained when the alloy of the noble metal pin for a spark plug electrode consists substantially of 30 to 60 mass % platinum, in particular 40 to 50 mass % platinum, 40 to 65 mass % nickel, in particular 50 to 60 mass % nickel, and 0.5 to 5 mass % iridium, and in particular 0.8 to 2 mass % iridium.

Furthermore, according to an example embodiment of the present invention, a spark plug is also provided, which comprises the first spark plug electrode and/or the second spark plug electrode. The spark plug according to the present invention is characterized by very good spark erosion behavior and thus by a low wear rate due to spark erosion. Formation of false sparks caused by improperly processed noble metal pins for spark plug electrodes connected to a spark plug electrode main body is also prevented, so that the spark plug has a permanently high mileage, especially in modern engines with high power density.

Furthermore, according to an example embodiment of the present invention, a first method for producing a spark plug electrode is also disclosed, which comprises a step of welding and in particular of back-side welding a noble metal pin for a spark plug electrode onto a nickel-based electrode main body. The noble metal pin for a spark plug electrode used for the welding method consists of an alloy containing more than 80 mass % platinum, 1 to 10 mass % nickel, and 1 to less than 10 mass % iridium. Due to the composition of the noble metal pin for a spark plug electrode, welding, which is carried out in particular by back-side welding, creates a homogeneous and thus permanently stable weld seam between the noble metal pin for a spark plug electrode and the nickel-based electrode main body, so that slipping or breaking out of the noble metal pin for a spark plug electrode is permanently prevented. The first method produces a spark plug electrode, namely a first spark plug electrode according to the present invention, which is characterized by high mileage with low spark erosion wear. The region used to form the ignition spark (ignition spark surface) of the inserted noble metal pin for a spark plug electrode during use as intended of the spark plug produced by the first method consists of an alloy containing more than 80 mass % platinum, 1 to 10 mass % nickel, and 1 to less than 10 mass % iridium.

According to an example embodiment of the present invention, a second method for producing a spark plug electrode is also disclosed, which comprises a step of completely alloying a noble metal pin for a spark plug electrode into a nickel-based electrode main body. In the second method, the noble metal pin for a spark plug electrode used also consists of an alloy containing more than 80 mass % platinum, 1 to 10 mass % nickel, and 1 to less than 10 mass % iridium. By completely alloying the noble metal pin for a spark plug electrode into the nickel-based electrode main body, the noble metal pin for a spark plug electrode changes its composition so that the composition of the noble metal pin for a spark plug electrode after completion of the spark plug electrode, which is in the form of a second spark plug electrode, is substantially as follows:
30 to 60 mass % platinum, in particular 40 to 50 mass % platinum,
40 to 65 mass % nickel, in particular 50 to 60 mass % nickel, and
0.5 to 5 mass % iridium, in particular 0.8 to 2 mass % iridium.

The second method also produces a spark plug electrode, namely a second spark plug electrode according to the present invention, which is characterized by a very high mileage with low spark erosion wear.

According to an example embodiment of the present invention, to further simplify the above methods by lowering the melting range of the noble metal pin for a spark plug electrode used for the methods, the alloy of the noble metal pin for a spark plug electrode used for welding consists substantially of more than 80 mass % platinum, in particular more than 90 mass % platinum, 1 to 10 mass % nickel, in particular 3 to 7 mass % nickel, and 1 to less than 10 mass % iridium, and in particular 1 to 3 mass % iridium.

### BRIEF DESCRIPTION OF THE DRAWINGS

Exemplary embodiments of the present invention are described in detail below with reference to the figures.

FIG. 1 is a partially sectioned view of a spark plug according to a first example embodiment of the present invention.

FIG. 2 is a schematic partial section of a spark plug according to a second example embodiment of the present invention in section.

FIG. 3 is a schematic partial section of a spark plug according to a third example embodiment of the present invention in section

FIG. 4 is a schematic partial section of a spark plug according to a fourth example embodiment of the present invention in section.

### DETAILED DESCRIPTION OF EXAMPLE EMBODIMENTS

In the figures, only the essential components of the present invention are shown, and all other components are omitted for the sake of clarity. Furthermore, the same reference signs identify the same parts/components.

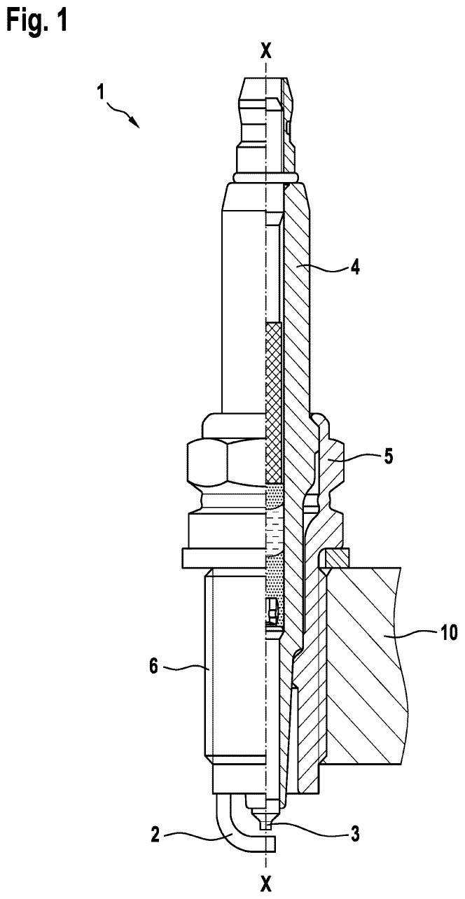

As can be seen in FIG. 1, the spark plug 1 comprises a ground electrode 2, a center electrode 3, and an insulator 4. A housing 5 at least partially surrounds the insulator 4. A thread 6, which is designed for fastening the spark plug 1 in a cylinder head 10, is arranged on the housing 5.

In particular the ground electrode 2, but alternatively or additionally also the center electrode 3, can be designed as a first spark plug electrode 8 or as a second spark plug electrode 9 as disclosed above.

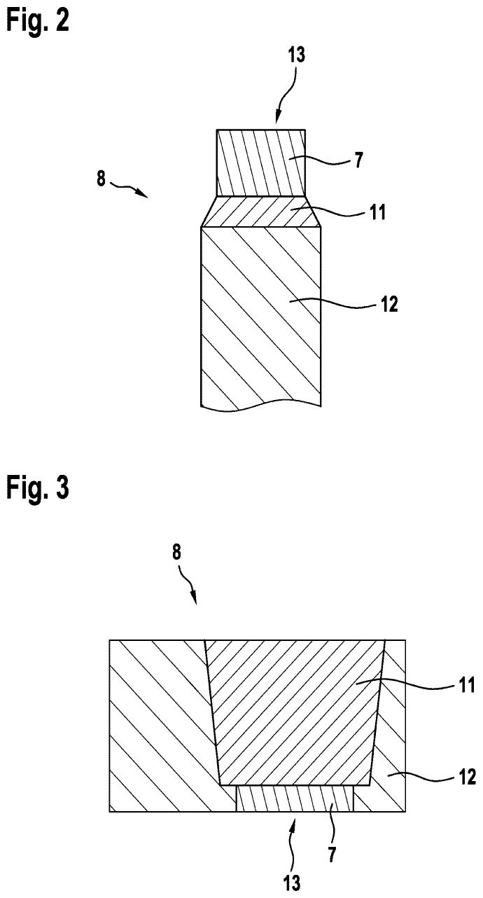

FIG. 2 shows a schematic detail of a first spark plug electrode 8, which is shown here as a center electrode by way of example. It comprises a spark plug electrode main body which is a nickel-based electrode main body 12 and comprises nickel with more than 50 mass %, based on the total mass of the nickel-based electrode main body 12. The nickel-based electrode main body 12 is connected to a noble metal pin 7 for a spark plug electrode by a weld seam 11.

The noble metal pin 7 for a spark plug electrode has an ignition spark surface 13 which, when the first spark plug electrode 8 is used as intended, serves to form the ignition spark and consists of an alloy containing more than 80 mass % platinum, 1 to 10 mass % nickel, and 1 to less than 10 mass % iridium.

Preferably, the alloy consists substantially of more than 80 mass % platinum, in particular more than 90 mass % platinum, 1 to 10 mass % nickel, in particular 3 to 7 mass % nickel, and 1 to less than 10 mass % iridium, and in particular 1 to 3 mass % iridium.

The welding of the noble metal pin 7 for a spark plug electrode to the nickel-based electrode main body 12 can be carried out using a conventional welding method, whereby the noble metal pin 7 for a spark plug electrode retains its composition substantially and in particular at the ignition spark surface 13. The weld seam 11 is characterized by very good stability and homogeneity, which is due to the fact that the above-mentioned composition of the noble metal pin 7 for a spark plug electrode comprises nickel with 1 to 10 mass %, thereby reducing the melting range of the noble metal pin 7 for a spark plug electrode and facilitating processability by welding. In addition, the noble metal pin 7 for a spark plug electrode is characterized by high spark erosion wear due to the high content of noble metals, so that the first spark plug electrode 8 has a high mileage.

FIG. 3 shows a schematic detail of a further first spark plug electrode 8, which is shown here as a ground electrode by way of example. The first spark plug electrode 8 comprises a spark plug electrode main body, which in turn is a nickel-based electrode main body 12 and comprises nickel with more than 50 mass %, based on the total mass of the nickel-based electrode main body 12. In contrast to the first spark plug electrode 8 of FIG. 2, the first spark plug electrode 8 of FIG. 3 is produced by back-side welding. This has the result that, at least at the surface that forms the connection with the nickel-based electrode main body 12, the composition of the noble metal pin 7 for a spark plug electrode in the welded region (see weld seam 11) changes, and consists of a mixed alloy of the alloy of the nickel-based electrode main body 12 and the alloy of the noble metal pin 7 for a spark plug electrode. However, the composition of the noble metal pin 7 for a spark plug electrode in the region of the ignition spark surface 13 still has the composition of the noble metal pin 7 for a spark plug electrode as before the back-side welding; that is, it consists of an alloy containing more than 80 mass % platinum, 1 to 10 mass % nickel, and 1 to less than 10 mass % iridium. Preferably, the alloy consists substantially of more than 80 mass % platinum, in particular more than 90 mass % platinum, 1 to 10 mass % nickel, in particular 3 to 7 mass % nickel, and 1 to less than 10 mass % iridium, and in particular 1 to 3 mass % iridium.

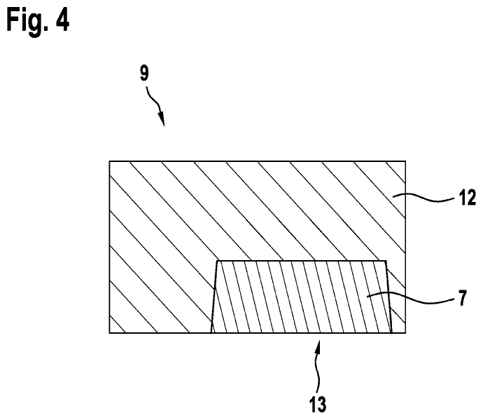

FIG. 4 shows a schematic detail of a second spark plug electrode 9, which is also shown here as a ground electrode by way of example. The second spark plug electrode 9 comprises a spark plug electrode main body, which is a nickel-based electrode main body 12 and comprises nickel with more than 50 mass %, based on the total mass of the nickel-based electrode main body 12.

A noble metal pin 7 for a spark plug electrode is completely alloyed into the nickel-based electrode main body 12. Therefore, there is no weld seam.

The noble metal pin 7 for a spark plug electrode also has an ignition spark surface 13 and consists of an alloy containing 30 to 60 mass % platinum, 40 to 65 mass % nickel, and 0.5 to 5 mass % iridium.

In particular, the alloy forming the noble metal pin 7 for a spark plug electrode consists substantially of 30 to 60 mass % platinum, in particular 40 to 50 mass % platinum, 40 to 65 mass % nickel, in particular 50 to 60 mass % nickel, and 0.5 to 5 mass % iridium, in particular 0.8 to 2 mass % iridium.

By completely alloying the noble metal pin 7 for a spark plug electrode into the nickel-based electrode main body 12, a particularly stable connection is formed between the noble metal pin 7 for a spark plug electrode and the nickel-based electrode main body 12, so that slipping or falling out of the noble metal pin 7 for a spark plug electrode is effectively prevented even during long-term use as intended of the second spark plug electrode 9, and yet very low spark erosion wear rates are maintained, so that the mileage of the second spark plug electrode 9 is permanently high.

1-11. (canceled)

12. A noble metal pin for a spark plug electrode, the pin including an alloy containing:
more than 80 mass % platinum;
1 to 10 mass % nickel; and
1 to less than 10 mass % iridium.

13. The noble metal pin for a spark plug electrode according to claim 12, wherein the alloy includes:
more than 90 mass % platinum,
3 to 7 mass % nickel; and
1 to 3 mass % iridium.

14. A spark plug electrode, comprising:
a noble metal pin for a spark plug electrode, the pin including an alloy containing:
more than 80 mass % platinum,
1 to 10 mass % nickel; and
1 to less than 10 mass % iridium.

15. The spark plug electrode according to claim 14, wherein the noble metal pin for the spark plug electrode is connected to a nickel-based electrode main body by a weld seam.

16. The spark plug electrode according to claim 14, wherein the alloy includes:
more than 90 mass % platinum;
3 to 7 mass % nickel; and
1 to 3 mass % iridium.

17. A spark plug electrode, comprising:
a noble metal pin for the spark plug electrode, wherein the noble metal pin for the spark plug electrode is completely alloyed into a nickel-based electrode main body, wherein the noble metal pin for the spark plug electrode includes an alloy containing:
30 to 60 mass % platinum,
40 to 65 mass % nickel, and
0.5 to 5 mass % iridium.

18. The spark plug electrode according to claim 17, wherein the alloy includes:
40 to 50 mass % platinum,
50 to 60 mass % nickel, and
0.8 to 2 mass % iridium.

19. A spark plug, comprising
a spark plug electrode including a noble metal pin for a spark plug electrode, the pin including an alloy containing:
more than 80 mass % platinum,
1 to 10 mass % nickel; and
1 to less than 10 mass % iridium.

20. A method for producing a spark plug electrode, comprising:
welding a noble metal pin for the spark plug electrode on a nickel-based electrode main body, the pin including an alloy containing:
more than 80 mass % platinum,
1 to 10 mass % nickel, and
1 to less than 10 mass % iridium.

21. A method for producing a spark plug electrode, comprising:
completely alloying a noble metal pin for a spark plug electrode into a nickel-based electrode main body, the pin including an alloy containing:
more than 80 mass % platinum,
1 to 10 mass % nickel, and
1 to less than 10 mass % iridium.

22. The method according to 20, wherein the alloy includes:
more than 90 mass % platinum,
3 to 7 mass % nickel, and
1 to 3 mass % iridium.
